(19) United States
(12) Patent Application Publication
(10) Pub. No.: US 2005/0251472 A1
(43) Pub. Date: Nov. 10, 2005

(54) Marketing of transaction cards

(76) Inventors: David B. Sutton, Monroe, MI (US); Douglas E. Blasiman, Bowling Green, OH (US)

Correspondence Address: HARNESS, DICKEY & PIERCE, P.L.C., P.O. BOX 828, BLOOMFIELD HILLS, MI, 48303, US

(21) Appl. No.: 11/121,318

(22) Filed: May 3, 2005

Related U.S. Application Data
(60) Provisional application No. 60/569,492, filed on May 7, 2004.

(51) Int. Cl. G06F 17/60; G06K 5/00

(52) U.S. Cl. 705/38; 235/380

(57) ABSTRACT

A method for marketing a secured transaction card is presented. A credit history of a person is determined. A request for a line of credit is denied. The secured transaction card is offered at the same time the person is informed that a line of credit is denied.

### FIELD OF THE INVENTION

The invention relates to marketing of transaction cards, and more particularly to offering a person a secured transaction card in response to denial of credit.

### BACKGROUND OF THE INVENTION

Increasingly, businesses such as financial institutions, retailers, merchants, service providers, and the like implement strict standards as to extending a line of credit (e.g. credit card, charge card etc.) to individuals. Consequently, a significant number of applications for a line of credit are denied. Denying a line of credit without offering an alternative may jeopardize future business with that person. For example, he may seek and find another bank to provide him with a credit card along with any other banking business.

While some businesses issue unsecured and secured transaction cards, the secured transaction card is not immediately offered to a person when an unsecured transaction card is denied. Secured transaction cards require a person to provide funds (e.g., cash, a certificate of deposit) that match the maximum credit line offered by the business before a secured transaction card is issued to a person. Additionally, the person may be required to maintain available funds for the secured transaction card on a periodic basis such as every month. Applicants for the credit line typically learn of secured transaction cards only after extensively researching the topic. It is therefore desirable to provide a method that overcomes the disadvantages associated with the present business method.

### SUMMARY OF THE INVENTION

One embodiment of the invention involves a method of marketing a secured transaction card by a business. The credit history of a person is determined. A request for a line of credit (e.g., an unsecured transaction card) is denied. The secured transaction card is offered during a time in which the person is informed that a line of credit is denied.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a flow diagram of a method for obtaining a secured transaction card in accordance with one embodiment of the invention;

FIG. 1B is a flow diagram of a method for obtaining a secured transaction card in accordance with one embodiment of the invention;

FIG. 2 is a flow diagram of a method for marketing a secured transaction card in accordance with one embodiment of the invention;

FIG. 3A illustrates a flow diagram from a point in which the consumer accepts an offer of the secured transaction card until the account is closed in accordance with one embodiment of the invention;

FIG. 3B illustrates a flow diagram from a point in which the consumer accepts an offer of the secured transaction card until the account is closed in accordance with one embodiment of the invention;

FIG. 4A is a front view of a secured transaction card that includes the cardholder's name in accordance with one embodiment of the invention;

FIG. 4B is a back view of a secured transaction card that includes the cardholder's name in accordance with one embodiment of the invention;

FIG. 4C is a front view of a secured transaction card without the name of the cardholder in accordance with one embodiment of the invention;

FIG. 4D is a back view of a secured transaction card without the name of the cardholder in accordance with one embodiment of the invention;

FIG. 5A is a flow diagram of a secured transaction card that is issued to a consumer for a post-paid service in accordance with one embodiment of the invention;

FIG. 5B is a flow diagram of a secured transaction card that is issued to a consumer for a post-paid service in accordance with one embodiment of the invention;

FIG. 5C is a flow diagram of a secured transaction card that is issued to a consumer for a post-paid service in accordance with one embodiment of the invention; and

FIG. 6 is a block diagram of one embodiment for a network system in which a secured transaction card is offered by a financial institution to a person.

### DETAILED DESCRIPTION OF THE PREFERRED EMBODIMENTS

Techniques of the invention involve an offer of a secured transaction card that is made at the same time a person is notified that he has been denied a line of credit (e.g., an unsecured transaction card such as a credit card, a charge card, etc.). A person may learn of the offer of the secured transaction card on-line, directly at the financial institution, telephonically, through the United States Postal Service, or other suitable means. By immediately offering a secured transaction card to a person, businesses are able to increase both their current and future business with customers that presently lack an adequate credit history to qualify for a line of credit.

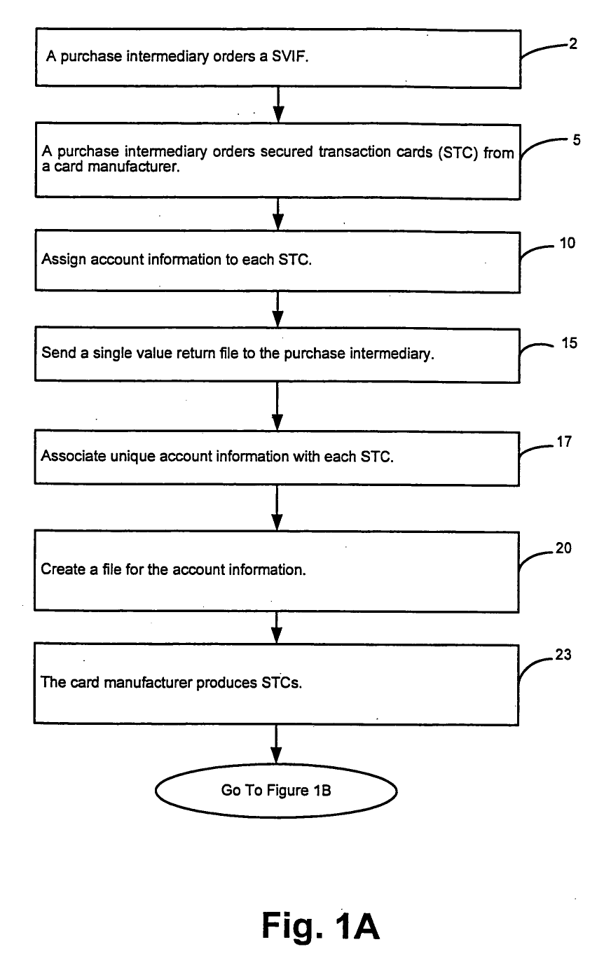

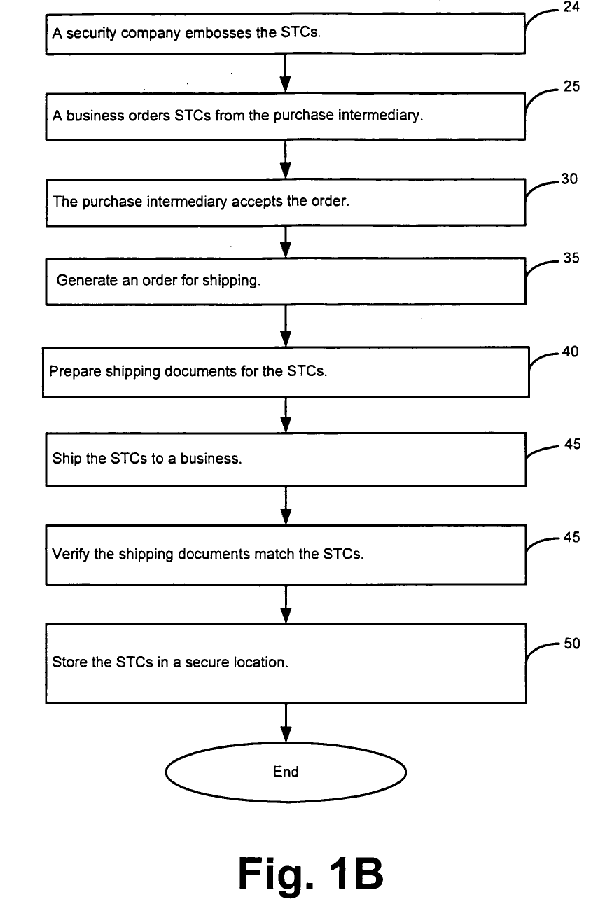

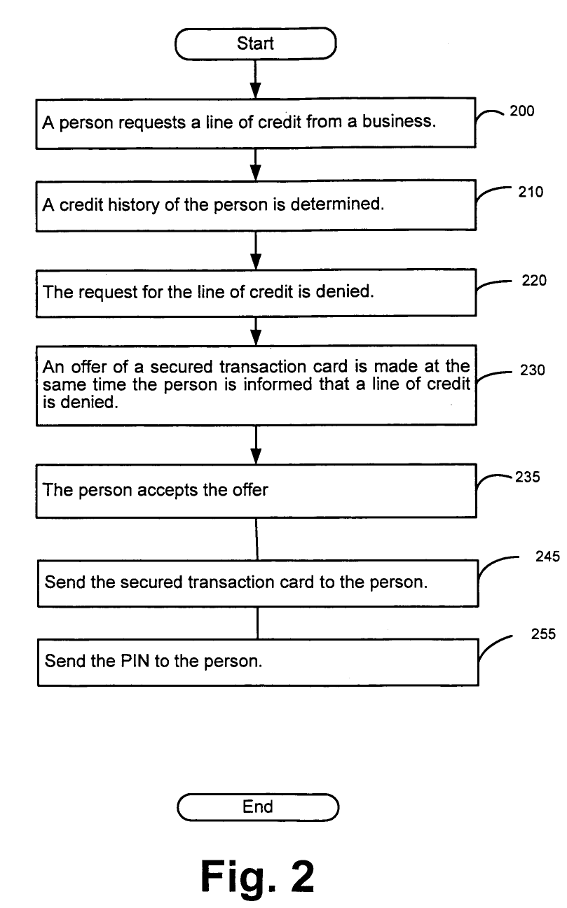

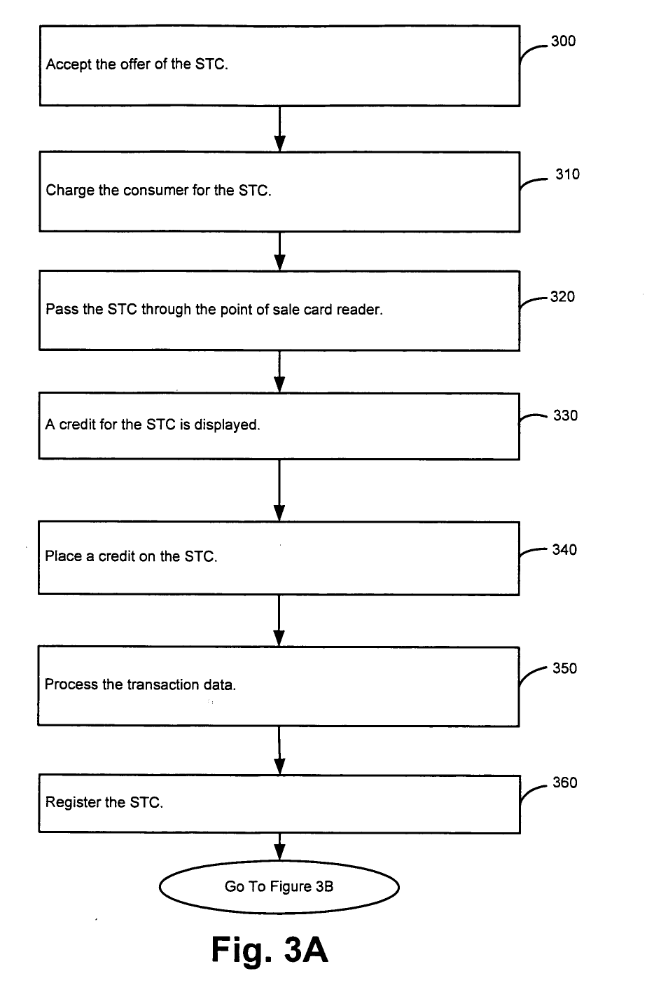

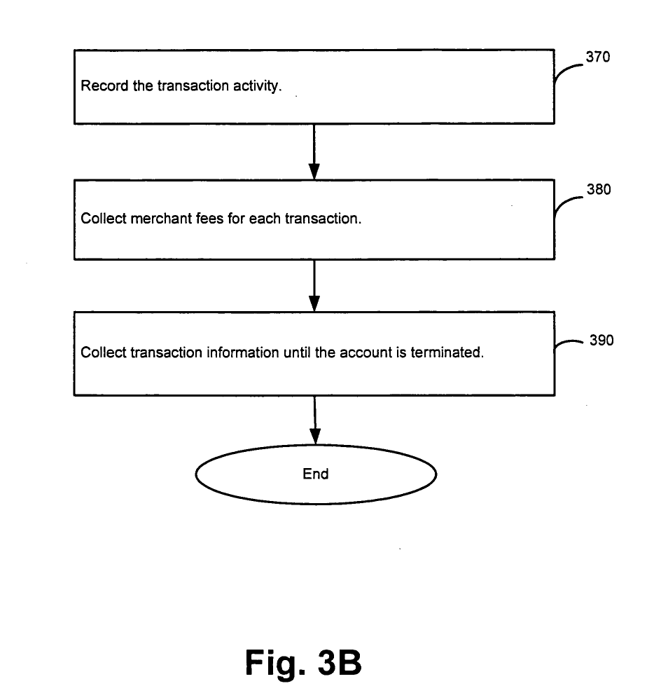

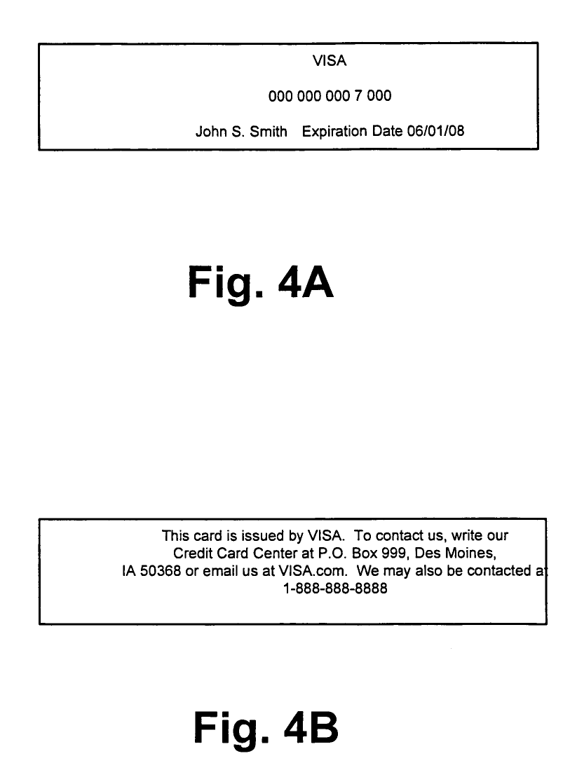

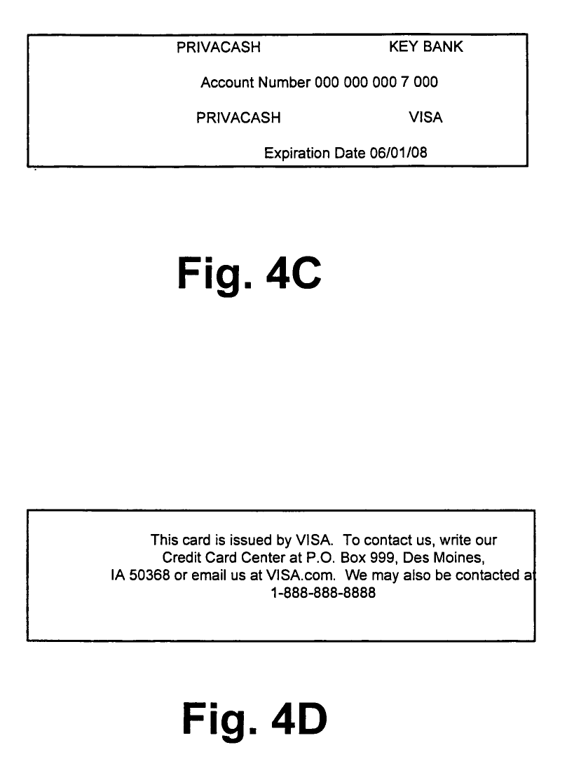

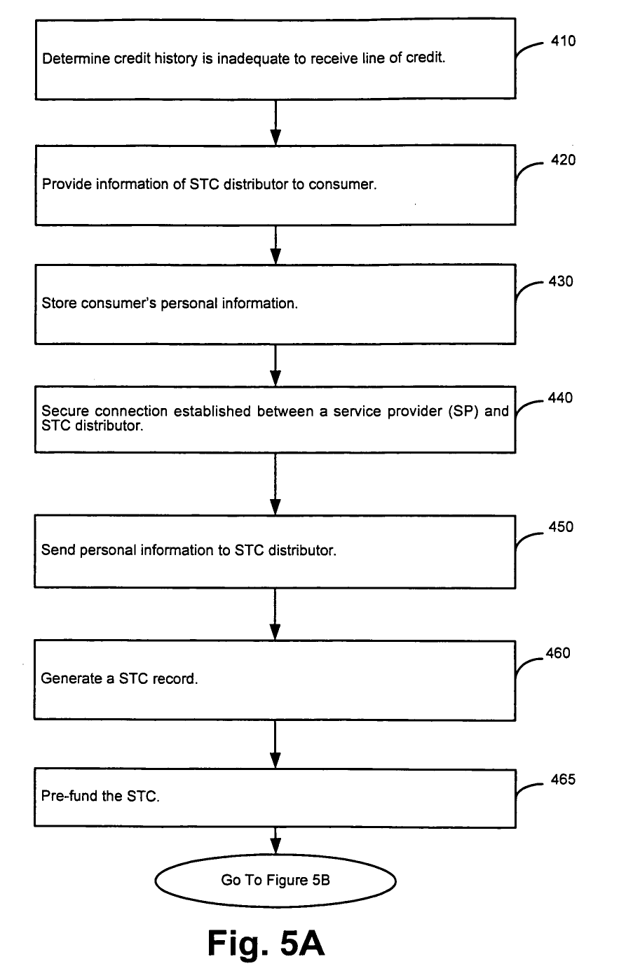

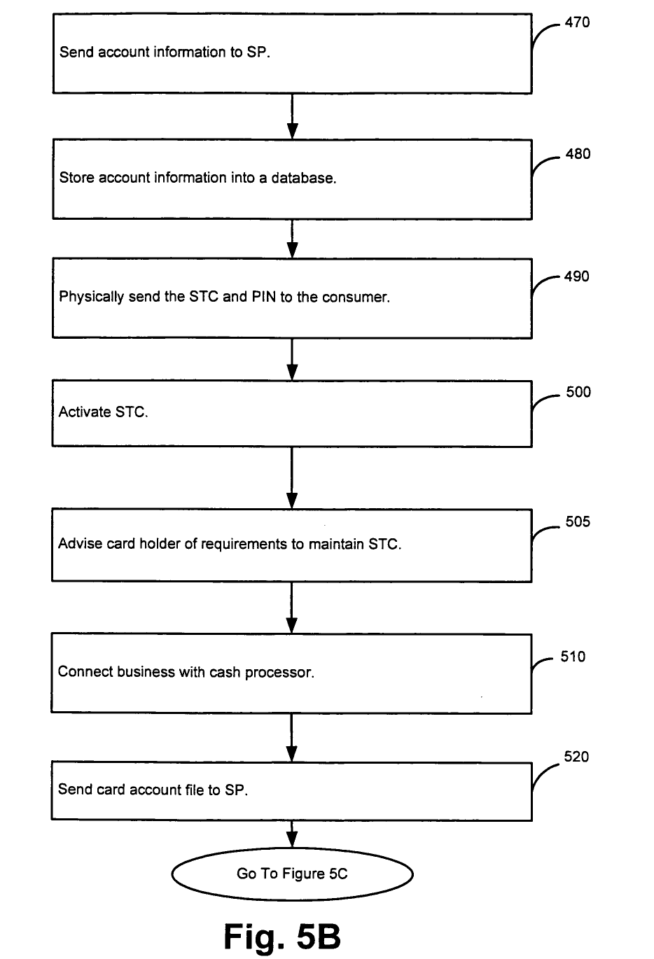

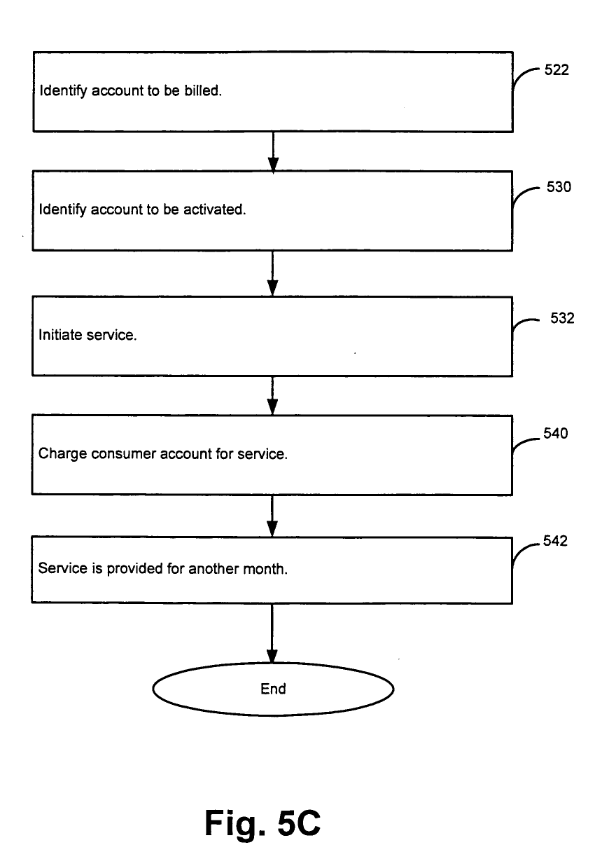

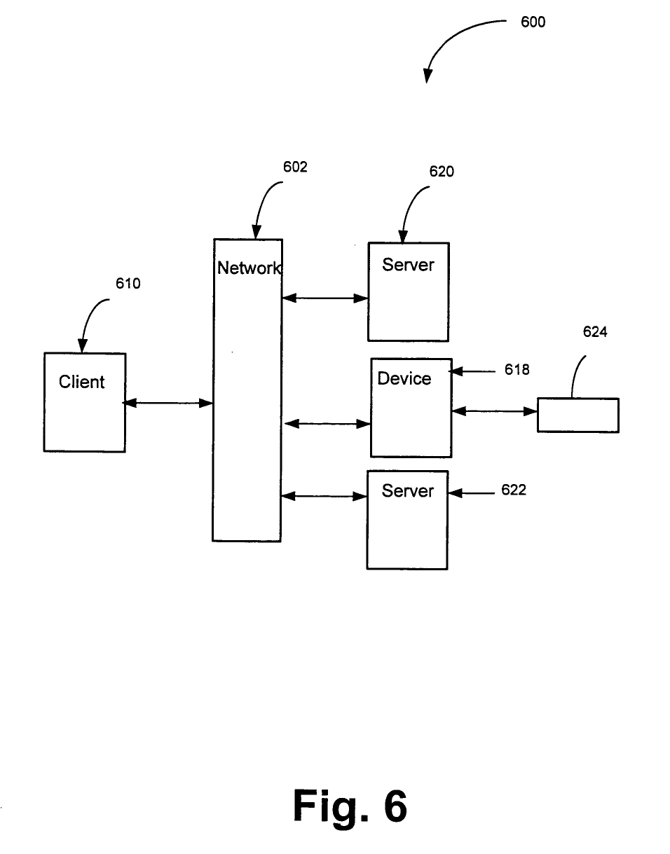

The discussion is parsed such that FIGS. 1A-1B illustrate the manner in which a secured transaction card, described relative to FIGS. 4A-4D, is obtained by a business; FIG. 2 illustrates a method in which to market a secured transaction card; FIGS. 3A-3B illustrate the operations that occur after a consumer accepts the secured transaction card; FIGS. 5A-5C illustrate a method of providing a secured transaction to be used for a post-paid service; and FIG. 6 illustrates a network system such as an on-line system in which a person is offered a secured transaction card and then obtains the secured transaction card from a device such as an automatic teller machine. The following description of the preferred embodiments is merely exemplary in nature and is in no way intended to limit the invention, its application, or uses.

Prior to considering an application for credit, a business such as a retailer, bank and the like may implement a series of steps shown in FIGS. 1A-1B to obtain secured transaction cards. At operation 2, a purchase intermediary sends a purchase order to a processing company to create a SVIF which is subsequently sent to a card company such as MasterCard, Visa and the like. At operation 5, a purchase intermediary orders from a card provider a certain number of secured transaction cards that are to be embossed with information. At operation 10, the card company assigns account information such as a secured transaction number (e.g. MASTERCARD numbers, VISA numbers etc.) and an expiration date for every secured transaction card. At operation 15, a single value return file (SVRF) is sent to a processing company over a communications link (e.g. facsimile, email etc.) from the card company.

At operation 17, the secured transaction card number and expiration date for every secured transaction card is then sent to an account blocking company such as the First Data Corporation to apply a block to those secured transaction card numbers. Blocking a secured transaction card number ensures that each number is uniquely assigned to a particular secured transaction card. At operation 20, the account blocking company then creates a file such as a cartridge file of secured transactions numbers and expiration dates in a format that is easily read by a card manufacturer such as Versatile Card Technology.

At operation 23, a card manufacturer manufactures secured transaction cards such as MasterCard, VISA etc. in an approved secure facility. The secured transaction card includes a magnetic strip, graphics, a web site address of the purchase intermediary, and other suitable information as shown in the front and back views of the card in FIGS. 4A and 4B, respectively. In this embodiment, the name of the cardholder is displayed. In another embodiment shown in FIGS. 4C-4D, the secured transaction card does not include the cardholder's name. This allows the cardholder to remain anonymous.

At operation 24, a security company such as Global Card Services (GCS) embosses the cards using the cartridge file received from the account blocking company. At operation 25, an order for the secured transaction card is generated and sent from a business such as a retailer, a banking center, and the like to the purchase intermediary through a facsimile or other communication means. At operation 30, the purchase intermediary accepts the order and prepares it for processing under an accounting system such as the Solomon Accounting System.

At operation 35, the purchase intermediary then generates and sends an order for a secured transaction card over a network such as through email to a secure shipping company (e.g., FXI). The order may include a store direct shipping address or other suitable information.

At operation 40, a secure shipping company prepares, prints, and sends shipping documents to a security company such as GCS for secure card delivery and storage. At operation 45, GCS then ships the cards along with the audit log sheets through, for example, the United States Postal Service to a business such as a retailer, a banking center, or other suitable business. At operation 48, at the business, an authorized employee checks the cards and matches the six digit number on the lower left hand corner of the secured transaction card to the number on the audit log. At operation 50, an authorized employee at a retail store places the cards in a central customer service secured storage area that is separate from a public area such as a check out area. On the other hand, if the authorized employee works at a banking center, the secured transaction cards are stored in a locked vault.

FIG. 2 illustrates a flow diagram for a method for marketing a secured transaction card by a business (e.g. a bank, a credit card company, a retailer etc.). At operation 200, a person requests a line of credit such as an unsecured credit card (e.g. a credit card, a charge card, etc.) from a business. Typically, a request for a line of credit involves completing a credit application. The credit application requires personal information from the user such as the user's full legal name, his social security number, date of birth, driver's license number, present home address, current work address, current workplace, telephone number, and any other applicable information.

At operation 210, a credit history of the person is determined. In one embodiment, the business may directly access this information through one of its databases. Alternatively, a credit history may be obtained by the business accessing this information from a credit reporting agency.

A credit history includes a variety of information such as a credit rating. A credit rating ranks an individual compared to other individuals in terms of repaying debts. A credit rating ranges from 450 to 850, with 850 representing the best rating available. The credit history also includes a list of the user's creditors and the payment history for each creditor. For example, a user may have several credit cards. One of the credit cards may include negative remarks such as a 120 day late payment in the last two years.

There are certain factors in a credit history that will automatically cause denial of an unsecured credit line by many financial businesses such as financial institutions. For example, a credit rating of 600 is typically deemed too low to qualify for an unsecured credit line (e.g., credit card). Additionally, failure to be current on present credit payments such as a mortgage payment may also cause denial of a credit line.

At operation 220, the request for an unsecured transaction card is denied. Generally, the unsecured transaction is denied because the person's credit history does not satisfy requirements established by the business.

At operation 230, the secured transaction card is offered at the same time the person is informed that the line of credit (e.g., unsecured transaction card) is denied. Typically, a business sends this information in a letter through the U.S. Postal Service to the person. A variety of other communication means may also be used to notify the person such as through email, telephonically, facsimile or other suitable means.

At operation 235, the person may accept the offer of the secured transaction card through a variety of ways such as through written or oral communication that may occur with the business telephonically, over a communications link, or other suitable means. At operation 245, after the person accepts the offer of the secured transaction card, the card is sent to the person in the mail. The secured transaction card may also be hand-delivered to the person from an employee of the business that offered the card. Alternatively, the person may receive the secured transaction card from a device such as an automatic teller machine (ATM) as described in greater detail relative to FIG. 6. At operation 255, shortly after receiving the secured transaction card, the person typically receives through the mail or over a communication link his or her unique personal identification number (PIN). By providing the secured transaction card and PIN in separate communications, there is less opportunity for an unscrupulous person from stealing and using the secured transaction card.

FIGS. 3A-3B illustrate a flow diagram from the point in which the consumer accepts the offer of the secured transaction card until his account is closed. At operation 300, the consumer accepts the offer of the secured transaction card from the business. For example, he indicates that he would like a $200 secured transaction card. At operation 310, an employee of the business goes to a secured storage area to remove the secured transaction card and charges the consumer $208.95 in exchange for the secured transaction card. The premium on this card is $8.95. At operation 320, the employee swipes the magnetic strip of the secured transaction card through a point of sale card reader that is programmed with secured transaction card software. At operation 330, the employee reads a credit equal to the total amount at the point of sale, for example, $208.95. At operation 340, the secured transaction software prompts the employee to place a credit (i.e., value load) on the secured transaction card without a corresponding debit.

At operation 350, transaction data related to the purchase of the secured transaction card is then processed daily (e.g., secured transaction cards purchased). At operation 360, the customer then registers the secured transaction card on the Internet, telephonically, or another suitable means. During registration, the person provides information such as the secured transaction number, the expiration date, a password, a date of birth, a social security number and other like information. After registration of the secured transaction card, the secured transaction card is able to be used.

At operation 370, the transaction activity associated with the secured transaction card is recorded. Transaction information includes the card balance, the transaction, the location of the transaction, a negative card balance, an amount of value load and other like information. At operation 380, merchant fees for each transaction are collected by the financial institution that issued the secured transaction card.

At operation 390, transaction information is collected until the account is closed or the card expires. Any remaining funds on the card are returned to the card member. Card members typically receive a thirty day notice before expiration of the card as to their rights.

FIGS. 5A-5C are flow diagrams of a secured transaction card that is offered and issued to a consumer for post-paid services in accordance with one embodiment of the invention. A post-paid service is a service that extends for a certain time period and is paid after the service has been provided. A typical post-paid service is a service such as utilities (e.g., electricity, gas heat, and water), telephone, cable television, cellular phone or other suitable service providers on a monthly basis. In this embodiment, the service provider includes as one of its services to notify consumers that distributors of secured transaction cards may allow the consumer to receive a service even if he lacks a credit history worthy of receiving a line of credit.

At operation 410, the service provider determines that the consumer's credit history is not worthy of receiving a line of credit. In one embodiment, the consumer fails to have a credit card or a checking account that may be debited if their account with the service provider was not paid on a timely basis. At operation 420, the service provider provides the secured transaction card distributor's information in order for the consumer to pay an account that may be offered to the consumer by the service provider. At operation 430, the service provider stores in a database personal information regarding the consumer. The personal information may include the consumer's name, home address, city, state, zip code, a social security number, and any other applicable information. At operation 440, the service provider and the distributor establish a secure file transfer connection in an acceptable protocol to transfer a consumer's account information. At operation 450, the service provider transmits the personal information of the consumer in a secure file to a secure service database for the secured transaction card by the card issuer or distributor.

At operation 460, the card issuer generates a secured transaction card record. At operation 465, the secured transaction card may be required to be pre-funded with an amount prior to the consumer receiving the card through, for example, the United States Postal Service. At this point, the secured transaction card is not activated which prevents the consumer from gaining access to the pre-funded amount.

At operation 470, the card issuer sends a file from its database to the service provider with account information that includes the account number in a proxy format, the expiration date of the secured transaction card and any other applicable information regarding the consumer. At operation 480, the service provider stores the information into a secure database such as a customer record database. This database is not connected to a network such as the Internet in which a computer “hacker” may gain access. This database also includes database fields that contain the type of service plan assigned to the consumer, the billing frequency, and other applicable information.

At operation 490, the card issuer or an agent of the card issuer mails the consumer their secured transaction card. A unique PIN is also sent to the cardholder. The PIN may be sent through a variety of means such as the United States Postal Service, an email, or any other suitable means.

At operation 500, the cardholder activates his card. In one embodiment, activation of the secured transaction card occurs by the cardholder contacting the customer support line from the service provider and providing the applicable information to register the secured transaction card. Typically, to register the secured transaction card, a variety of information is presented such as the secured transaction card number, the expiration date, a password, and any other suitable information. In another embodiment, the cardholder may activate his card by inputting this information over the Internet.

In real-time, the card issuer executes a balance adjustment of, for example, $10 and transmits these funds to a settlement account for the service provider. The settlement account is tied to the consumer's account from the service provider. The card issuer then enables the card for the cardholder. At operation 505, the card issuer advises the cardholder of the requirements to maintain the secured transaction card. For example, sufficient funds must be maintained on their secured transaction card in order to maintain service from the service provider. The cardholder is also advised as to a location in which the secured transaction card may be reloaded with sufficient funds. At operation 510, a business such as a retailer may have direct connections with cash processors (e.g., Western Union locations, etc.) that typically have near real-time card account loading. Other retailers may provide reload stations that conform to a batching process that delay funds from appearing on the secured transaction card for a certain time period.

At operation 520, the card issuer transmits a card account file to the service provider on a daily basis. At operation 522, the service provider executes a database routine matching secured transaction card accounts that require either a payment applied to the initial service and activated or payment applied to their on-going monthly service. At operation 530, with respect to the scenario of initial activation, the service provider identifies the account number of the customer for activation. At operation 532, the service provider sends to the card issuer a file that instructs the card issuer to charge the secured transaction card for the corresponding service amount through the service provider's merchant account associated with a settlement account at the cardholder's bank. The funds appear on the settlement account according to the terms of the specific agreement with the merchant processor.

At operation 532, after receiving a transaction authorization, the service provider initiates service to the cardholder. Alternatively, if the charge transaction is declined, the service provider initiates a charge to the customer's card after receipt of a funding file from the card issuer which indicates the account has sufficient funds.

At operation 540, with respect to the scenario involving an on-going monthly service, the service provider identifies service customers in which a payment is due and initiates a charge for their monthly service to their account. At operation 542, upon receiving a transaction authorization, service is provided for another month. Alternatively, in the situation in which the cardholder's account is nearing its due date, and lacks sufficient funds to pay for the service for the subsequent month (based on daily funding files transmitted to the service provider by the secured transaction card issuer) the service provider may issue a notice to the cardholder indicating that a possibility of an interruption of service exists. For example, the service provider such as the telephone company or a cellular phone company may initiate a dial tone warning if sufficient funds are not on the card within a certain time period such as within seven days of the due date. This warning may escalate to a more urgent dial tone notice if funds are not loaded within three days of the due date. If funds are not on the card on the due date, the telephone service may be interrupted.

If the service is interrupted, the service provider continues to receive card funding files on a daily basis from the card issuer indicating the card loads to the customers with an outstanding balance. If service is interrupted, the service provider may charge a reconnection fee that is deducted from the account of the secured transaction card. The reconnection fee is deducted before funds are available to pay for the next month of service. If sufficient funds are available, the service provider reactivates the customer's service. Alternatively, if funds are not available, the service provider continues to receive records indicating when the funds are available. By implementing these operations, service providers are able to maintain a mutually beneficial relationship with the consumer. Additionally, the cardholder may be able to use the secured transaction card with other merchants, make cash withdrawals, card-to-card money transfers, etc.

Referring to FIG. 6, a system 600 for implementing techniques of the invention involves a client/server network. Other suitable networks such as a peer-to-peer network may also be used. The system 600 includes a client 610, a network 602, servers 620, 622, a device 618, and a secured transaction card 624. Each of these components is briefly described. Client 610 is a computer that sends and retrieves information from a server such as servers 620, 622. Network 602 may be a wide-area network (WAN), the Internet, or other suitable network. Servers 620, 622 control software, access to printers, and other relevant tasks. The device 618 such as an ATM is configured to issue and to track the amount of money placed on the secured transaction card 624. In one embodiment, the secured transaction card 624 is physically indistinguishable from a typical credit card, as shown in FIGS. 4A and 4B. In another embodiment, the secured transaction card maintains the anonymity of the cardholder as shown in FIGS. 4C-4D. The secured transaction card 624 includes an account number, the name of the secured transaction card company (e.g. VISA, MasterCard, American Express etc), and the expiration date of the secured transaction card 624.

Techniques of the invention involve a user sending a request for a line of credit (e.g. an application for a credit card) from the client 610 over the network 602 to the server 620. In the request, personal information from the user is included such as the user's full legal name, his social security number, date of birth, driver's license number, present home address, current work address, current workplace, telephone number, and any other applicable information.

After receiving the request for an unsecured credit line, server 620 accesses the person's credit history. The server 620 may have direct access to the person's credit history through a database (not shown) or the server 620 may be required to access the credit history of another server 622 from a credit reporting agency such as TransUnion, Equifax, or Experian.

The server 620 applies a set of rules to determine whether the user has an adequate credit history to allow an unsecured transaction card to be issued to him. Once the server 620 determines that the user does not qualify for an unsecured credit line, the server 620 sends a message to the client 610 over the network 602 indicating that the user has been denied an unsecured credit line. In this same message, the user is offered a secured transaction card 624. Alternatively, the user is provided with names of companies that issue secured transaction cards in the same message regarding the denial of a credit line.

If the user accepts the offer of a secured transaction card 624, the server 620 provides a unique code to the user over network 602. The user inputs the code into the device 618 within a certain time period. The code authorizes the user to receive the secured transaction card 624, provided secured funds are available for the secured transaction card 624. In one embodiment, the secured funds are linked to an account of the user. In another embodiment, the user inputs money into device 618 to receive the secured transaction card 624. After the person has inserted all the money that he desires to be placed on the secured transaction card 624, he indicates through a graphical user interface (GUI) on the device 618 that he has completed the task of inputting the money. The device 618 determines the total amount of money that has been placed on the secured transaction card 624 and provides this information to the person on the GUI or through a printed receipt.

In one embodiment, the device 618 generates the secured transaction card 624 that includes a secured transaction card 624 account number, the person's name, the expiration date, and other applicable information. Some of this information such as the person's name and the expiration of the secured transaction card 624 is stamped or embossed into the secured transaction card 624 on a real-time basis. Including the name of the cardholder on the secured transaction card allows the person to present the card to a merchant in the same manner that a credit card is presented. Including a name on the card may avoid questions from a merchant. Avoiding questions may be important to some cardholders who, for example, are with a group of people.

In another embodiment, the person's name is left off the secured transaction card as shown in FIGS. 4C-4D. The secured transaction card 624 is then outputted from the device 618 to the person.

In one embodiment, the person registers the secured transaction card 624 either over the network 602, by telephone, or directly at the financial institution. Registration involves inputting information such as the card number, the expiration date, the password, the date of birth, the social security number, and email address (if available). After the registration process, the funds on the secured transaction card 624 may be used by the cardholder. This process allows the user to obtain the secured transaction card 624 beyond the typical business hours such as on a Saturday, a Sunday, or a holiday.

As the funds are used on the secured transaction card, the system 600 captures the card activity and generates a variety of reports that include the secured transaction card 624 balance, transactions, the location of the transaction, negative card balance, the amount of value load, and other relevant information. The system 600 continues to monitor the activity on the secured transaction card account and collect monthly transaction cardholder fees debited from the available balance on the cardholder account until the account is closed or the card expires on the date embossed on the secured transaction card 624.

Cardholders who provide an email address or mailing address receive notice thirty days before the transaction card expiration date advising them of a variety of information such as they may be able to renew the transaction card, as well as how to obtain funds from the transaction card should they choose to close the account.

It will be appreciated that more or fewer processes may be incorporated into the method illustrated in FIGS. 1A-1B, 2, 3A-3B, and 5A-5C without departing from the scope of the invention and that no particular order is implied by the arrangement of blocks shown and described herein. Skilled artisans will appreciate that the method described in conjunction with FIGS. 1A-1B, 2, 3A-3B, and 5A-5C may be embodied in machine-executable instructions (e.g., software). The instructions can be used to cause a general-purpose or special-purpose processor that is programmed with the instructions to perform the operations described. Alternatively, the operations may be performed by specific hardware components that contain hard-wired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” includes any medium that is capable of storing or encoding a sequence of instructions for execution by the machine and that cause the machine to perform any one of the methodologies of the present invention. The term “machine-readable medium” includes, but is not be limited to, solid-state memories, optical and magnetic disks, and carrier wave signals. Furthermore, it is common in the art to speak of software, in one form or another (e.g., program, procedure, process, application, module, logic, etc.), as taking an action or causing a result. Such expressions are merely a shorthand way of saying that the execution of the software by a computer causes the processor of the computer to perform an action or a produce a result.

In the preceding detailed description, the invention is described with reference to specific embodiments thereof. It will, however, be evident that various modifications and changes may be made thereto without departing from the broader spirit and scope of the invention as set forth in the claims. The specification and drawings are, accordingly, to be regarded in an illustrative rather than a restrictive sense.

1. A method for marketing a secured transaction card by a business comprising:
determining a credit history of a person;
denying a request for an unsecured transaction card; and
offering the secured transaction card at a time in which the person is informed that the unsecured transaction card is denied.

2. The method of claim 1 wherein the offer of the secured transaction card is made through one of a postal system, a network, and a telephone call.

3. The method of claim 2 wherein the offer of the secured transaction card is included in a single communication between the business and the person.

4. The method of claim 1, further comprising:
issuing an unsecured transaction card that is physically indistinguishable from an unsecured transaction card.

5. An article comprising:
a storage medium including instructions stored thereon which, when executed, cause a computer system to perform a method including:
determining a credit history of a person;
denying a request for an unsecured transaction card; and
offering a secured transaction card during a time in which the person is informed that an unsecured transaction card is denied.

6. The article of claim 5 wherein the computer system requires that the offer of the secured transaction card be made through one of a postal system, a network, and a telephone call.

7. The article of claim 5 wherein the offer of the secured transaction card is included in correspondence between a business and the person.

8. The article of claim 5 in which the computer system further comprises:
issuing the secured transaction card that is physically indistinguishable from an unsecured transaction card.

9. An apparatus for marketing an secured transaction card comprising:
a first device;
a second device coupled to the first device over a network;
the first device configured to send personal identification information over the network to the second device;
the second device configured to access a credit history of a person, send a message to the first device that denies a request for an unsecured transaction card, and to send an offer to the first client of the secured transaction card.

10. The apparatus of claim 9 wherein the offer of the secured transaction card is made through one of a postal system, a network, and a telephone call.

11. The apparatus of claim 10 wherein the secured transaction card that is physically indistinguishable from an unsecured transaction card is issued through a third device coupled to the second device.

12. A method for marketing a secured transaction card by a financial institution comprising:
sending personal information of a user from a device to a server over a network;
determining a credit history of the person based upon the personal information by the server;
denying a request for an unsecured transaction card by the server; and
sending an offer of a secured transaction card at a same time the person is informed that the unsecured transaction card is denied.

13. The method of claim 12 further comprising:
delivering the secured transaction card to person.

14. A method for marketing a secured transaction card by a financial institution comprising:
requesting an unsecured transaction card from the financial institution;
determining a credit history of a person;
denying a request for an unsecured transaction card; and
offering the secured transaction card during a time in which the person is informed that the unsecured transaction card is denied.

15. A method for marketing a secured transaction card by a financial institution comprising:
sending a request for an unsecured transaction card from a client to a first server;
determining a credit history of a person by the first server accessing a second server;
sending a denial of the request for an unsecured transaction card from the first server to the client; and
offering the secured transaction card during a time in which the person is informed that the unsecured transaction card is denied.

16. The method of claim 15 further comprising:
inputting a unique code into a device coupled to the first server.

17. The method of claim 16 further comprising:
inputting money into the device coupled to the first server.

18. The method of claim 17 further comprising:
tracking an amount of money placed on the secured transaction card.

19. The method of claim 17 further comprising:
delivering the secured transaction card to a user.

20. The method of claim 15 further comprising:
tracking transactions associated with the secured transaction card.

21. A method for obtaining a post-paid service comprising:
determining a credit history of a person;
denying a line of credit to the person; and
providing in a single communication to the person that a credit line is denied and a secured transaction card is an acceptable form of payment.

22. The method of claim 21, wherein a post-paid service is a utility service.

23. The method of claim 22, wherein the utility is one of a service for providing water, electricity and gas heat.

24. The method of claim 21, wherein the post-paid service is related to one of a telephone service and a cellular phone service.

25. The method of claim 21 further comprising:
providing the secured transaction card that ensures the anonymity of the person.

26. The method of claim 1 further comprising:
providing the secured transaction card that is physically indistinguishable from an unsecured transaction card.

27. An article comprising:
a storage medium including instructions stored thereon which, when executed, cause a computer system to perform a method including:
determining a credit history of a person;
denying a line of credit to the person;
providing in a single communication to the person that a credit line is denied and a secured transaction card is an acceptable form of payment;
verifying that the person obtained a secured transaction card; and
extending a service to the person.
